(19) United States
(12) Patent Application Publication
(10) Pub. No.: US 2005/0209999 A1
(43) Pub. Date: Sep. 22, 2005

(54) Systems and methods for class designation in a computerized social network application

(76) Inventor: Kenny Jou, La Puente, CA (US)

Correspondence Address: JONES DAY, 555 SOUTH FLOWER STREET FIFTIETH FLOOR, LOS ANGELES, CA, 90071, US

(21) Appl. No.: 10/804,579

(22) Filed: Mar. 19, 2004

(51) Int. Cl. G06F 7/00

(52) U.S. Cl. 707/2

(57) ABSTRACT

Computer program products, methods, and systems for facilitating a computerized social network. The computer program products and systems include a user profile database and a social networking module. The user profile database comprises a plurality of personal profiles. Each respective personal profile in the plurality of personal profiles corresponds to a respective user in the computerized social network. Further, each respective personal profile in the plurality of personal profiles includes an identity of at least one user of the computerized social network other than the user represented by the respective personal profile. In addition, each respective personal profile in the plurality of personal profiles includes a capability to organize each of the at least one users into one or more groups associated with the user corresponding to the respective personal profile. The social networking module has a friend access routine that includes instructions for receiving a request from a first user to access users in the personal profile of a second user. The friend access routine further includes instructions for determining which of the users in the personal profile of the second user can be accessed by the first user.

### FIELD OF THE INVENTION

This invention relates to the creation of groups with different privilege classes in a computerized social network.

### BACKGROUND OF THE INVENTION

With the expansion of the Internet as a social tool, a number of online social networking programs have emerged including Friendster.com (Friendster, Inc., Sunnyvale Calif.), Ringo (www.ringo.com), “Everyone's Connected” (www.everyonesconnected.com), Tribe (www.tribe.net), Peepsnation, (www.peepsnation.com), Friends of Friends (www.friendsoffriends.com), WhizSpark (www.whizspark.com), Friendzy (www.friendzy.com), FriendSurfer (www.friendsurfer.com), MySpace (www.myspace.com), Impersonals (www.impersonals.com), Hi5 (www.hi5.com), BlogPod (www.blogpod.com), Hipstir (www.hipstir.com), Plink (beta.plink.org), NetFriendships (www.netfriendships.com), Friendity (www.friendity.de), and Squiby (www.squiby.com).

Such applications allow users to create a personal and private networking community in which users network through friends, friends of friends, and so forth. A user begins by creating a personal profile that includes the names of the user's friends. Contact and personal profile information of friends of friends can be reviewed. In fact, one of the main advantages of such applications is that a user can browse and search through all of the users connected to a user through networks of friends. A user can view photos and profiles, see how the user is connected to other users, send messages, ask friends for introductions, or suggest matches between friends or even friends of friends. Such applications can be used for all types of social networking, including making friends, meeting other couples, or people with kids, etc.

Traditional online dating services are based on searching through large numbers of anonymous profiles. In contrast, social networking programs are based on networking through a user's friends. A user's photo and profile is shown only to people in a user's personal network. A user sends and receives messages only with users connected to the user through a series of mutual friends. A user is able to see how he is connected to people he is interested in, and either contact them directly, or ask a friend to make an introduction. A user's social network can include hundreds or even thousands of people. Each new friend that a user or one of the user's friends add to their personal profile could bring over hundreds of new people into the user's personal network.

As can be appreciated, such social networking provides powerful methods for meeting new people. It is based upon the concept of friends adding friends. Each user's profile shows the friends of the user. Clicking on a particular friend shows the friends of the particular friend, and so forth. In the end, one obtains a huge network of people, all inter-connected through this common network of friends.

While known social networking applications have significant value, they all suffer from certain drawbacks that make their use somewhat unsatisfactory. In such applications, the network of friends is completely transparent. In other words, everyone in a user's social network has the same privileges. This is contrary to real life social networks. In real life, people have different groups of friends. For example, consider a user that has a group of co-worker friends, and another group of high school friends. Members of these two groups may not necessarily know each other, or may not have anything in common with each other, other than the fact that they both know the user. Not only this, but perhaps the user would prefer to not let his high school friends know anything about his co-worker friends (number of friends, who they are, what comments/bulletin board posts they might make, etc.). Known social networking applications do not provide functionality that allows a user to specify groups of friends and to give each such group special access privileges.

Accordingly, what is needed beyond the prior art is improved networking functionality that allow a user to specify circles of friends and to grant such circles of friends certain access privileges.

### SUMMARY OF THE INVENTION

The present invention addresses the shortcoming of known social networking applications. In the present invention, a user can specify groups. Further, in some embodiments, the user can specify public and private groups. Using the example from above, in accordance with the present invention, a given user can create two or more distinct groups. In one example, the given user designates one group for “co-workers” and another for “high school friends.” If the given user doesn't want anyone to know about his co-workers, he can designate the “co-workers” group as private. Generally, once a private group has been set, only users within the private group know of the existence of the group or are able to communicate with other members of this group when viewing the given user's profile. Members from a public group, such as the “high school friends” group, will not know of the existence of such a private group, nor will they see members in that group listed among the given user's friends when viewing the user's profile.

If the given user doesn't mind other people knowing about the “high school friends” group, he can designate the group as public group, meaning that, subject to certain rules, other users can see the existence of this group public, and also the members in it. This means friends in the given user's private “co-workers” group might be able to see the members of the “high school friends group”, while the friends in the user's “high school friends” group won't be able to see the “co-workers” members.

The idea of personal groups, besides being a way to categorize and privatize certain groups of friends, can also be used to encapsulate a personal community of friends. Consider again the example where a given user has designated a private “co-workers” group and a public “high school friends” group. In the present invention, a given user is able to send bulletin board posts to just the group “co-workers,” and the members in this group will also be able to respond back. However, nobody outside of this private group will be able to view their messages. An example would be when the given user posts a message about a company retreat. Nobody but people in the “co-workers” group has any business knowing about the retreat, and since the “co-workers” group is set as a personal private group, nobody else will know about the retreat.

The present invention protects the identity of members of a private group. For example, consider the case where the given user who has designated a “co-workers” group as private. Suppose the given user has a co-worker A. Since A and the given user are co-workers, A is in the personal private group “co-workers”. If a third user B, who is not in the given users “co-workers” group, views A's profile, he should not be able to see that the given user and A are friends. In other words, the third user should not be able to determine that A and the given user are somehow connected by viewing A's profile instead of the given user's profile. Since the idea of private groups revolves around privacy, this does not happen in the systems and methods of the present invention. When the given user puts A in a personal private group, no one else outside of that personal private group can realize this bond between the given user and A, regardless of whether the given user's profile or A's profile is queried.

In the systems and methods of the present invention, personal groups can have overlapping members. For example, one of the given user's co-workers, say user B, might also be a high school friend. In this case, the given user would be placed in both the private “co-workers” group and the public “high school friends” group. Subject to rules defines further below, an outsider may be able to see that the given user and user B are friends because of the placement of B in the public group “high school friends.” This makes sense because the public relationship takes precedence. However, only members of the private “co-workers” group will know that user B is in the “co-workers” private group. No one else outside of that group will know the members in it, nor would they know the group exists in the first place. They will see user B in the “high school friends” group only.

One embodiment of the present invention comprises a computer program product for use in conjunction with a computer system. The computer program product comprises a computer readable storage medium and a computer program mechanism embedded therein. The computer program mechanism comprises a user profile database comprising a plurality of personal profiles. Each respective personal profile in the plurality of personal profiles corresponds to a user in a computerized social network. Further, each respective personal profile in the plurality of personal profiles includes an identity of at least one user other than the user represented by the respective personal profile. Further still, each respective personal profile in the plurality of personal profiles includes a capability to organize each of the at least one users into a plurality of groups associated with the user corresponding to the respective personal profile. The computer program mechanism further comprises a social networking module for supporting the computerized social network. The social networking module further comprises a friend access routine that includes (i) instructions for receiving a request from a first user to access users in the personal profile of a second user, and (ii) instructions for determining which of the users in the personal profile of the second user can be accessed by the first user.

Still another embodiment of the invent provides a computer system for hosting a computerized social network. The computer system comprises a central processing unit and a memory coupled to the central processing unit. The memory stores a user profile database and a social networking module. The user profile database comprises a plurality of personal profiles. Each respective personal profile in the plurality of personal profiles corresponds to a user in the computerized social network. Each respective personal profile in the plurality of personal profiles further includes an identity of at least one user other than the user represented by the respective personal profile. Each respective personal profile in the plurality of personal profiles also includes a capability to organize each of the at least one users into one or more groups associated with the user corresponding to the respective personal profile. The social networking module comprises a friend access routine that includes instructions for receiving a request from a first user to access users in the personal profile of a second user. The friend access routine further includes instructions for determining which of the users in the personal profile of the second user can be accessed by the first user.

Still another embodiment of the present invention provides a computer program product for use in conjunction with a computer system. The computer program product comprises a computer readable storage medium and a computer program mechanism embedded therein. The computer program mechanism is for facilitating a computerized social network and comprises a user profile database. The user profile database, in turn, comprises a plurality of personal profiles. Each respective personal profile in the plurality of personal profiles corresponds to a different user in a computerized social network. Further, each respective personal profile in the plurality of personal profiles includes an identity of at least one user of the computerized social network other than the user represented by the respective personal profile. Further still, each respective personal profile in the plurality of personal profiles includes a capability to organize each of the at least one users into one or more groups associated with the user corresponding to the respective personal profile.

Yet another embodiment of the present invention provides a method for determining which of a plurality of users in a personal profile of a second user can be accessed by a first user. The plurality of users are organized into a plurality of groups in the personal profile. In the method, a request from the first user to access the plurality of users in the personal profile of the second user is received. The first user and the second user are participants in a social network. A group in the plurality of groups in the personal profile of the second user is then selected. A determination is made as to whether this group is a private group or a public group. When the group is a public group, the group is added to an accessible group list. When the group is a private group, a determination is made as to whether the first user is a member of the private group. When the first user is a member of the private group, the group is added to the accessible group list. When the first user is not a member of the private group, the group is not added to the accessible group list. These steps are repeated until each group in the personal profile of the second user has been evaluated. The first user is granted access to users in each of the groups in the accessible group list.

In some embodiments, the grant to the first user of each of the groups in an accessible group list includes selecting a user C from a group G in the accessible group list and determining whether the second user is in a public group in a personal profile associated with this user. When the second user is in a public group defined by the personal profile associated with the user C, the user C is added to an access list. When the second user is not in a public group defined by the personal profile associated with the user C, a determination is made as to whether the first user and the second user are both in the same private group defined by the user C's personal profile. When the first user and the second user are both in the same private group defined by user C's personal profile, user C is added to the access list. When the first user and the second user are not both in the same private group defined by user Cs personal profile, user C is not added to the access list. These steps are repeated until each user C in each group G in the accessible group list has been considered. The first user is granted access to each user in the access list.

Still another embodiment of the present invention provides a method for hosting a social network that includes a user profile database comprising a plurality of personal profiles. Each respective personal profile in the plurality of personal profiles corresponds to a user in the social network. Each respective personal profile in the plurality of personal profiles includes an identity of at least one user other than the user represented by the respective personal profile. Each respective personal profile in the plurality of personal profiles includes a capability to organize each at least one user into one or more groups associated with the user corresponding to the respective personal profile. In the method, a request from a first user to access users in the personal profile of a second user is received. A user C is selected from a group G in the personal profile of the second user. A determination as to whether the second user is in a group in a personal profile associated with the user C is made. When the second user is in a group defined by the personal profile associated with the user C, the user C is added to an access list. When the second user is not in a group defined by the personal profile associated with the user C, the user C is not added to the access list. These steps are repeated until each user in each in the personal profile of the second user has been considered. The first user is granted access to each user in the access list.

### BRIEF DESCRIPTION OF THE DRAWINGS

FIG. 1 illustrates a computer system capable of class designation in a computerized social network application in accordance with one embodiment of the present invention.

FIG. 2 illustrates an exemplary user personal profile for use by a computer system capable of class designation in a computerized social network application.

FIGS. 3A and 3B illustrate processing steps for determining which friends of user B can be viewed by user A in a computerized social network application in accordance with an embodiment of the present invention.

FIG. 4 illustrates an access array data structure in accordance with one embodiment of the present invention.

FIG. 5 illustrates a permissions data structure used within a personal private group or a personal public group in accordance with one embodiment of the present invention.

FIG. 6 illustrates a photo album data structure associated with user in accordance with one embodiment of the present invention.

Like reference numerals refer to corresponding parts throughout the several views of the drawings.

### DETAILED DESCRIPTION

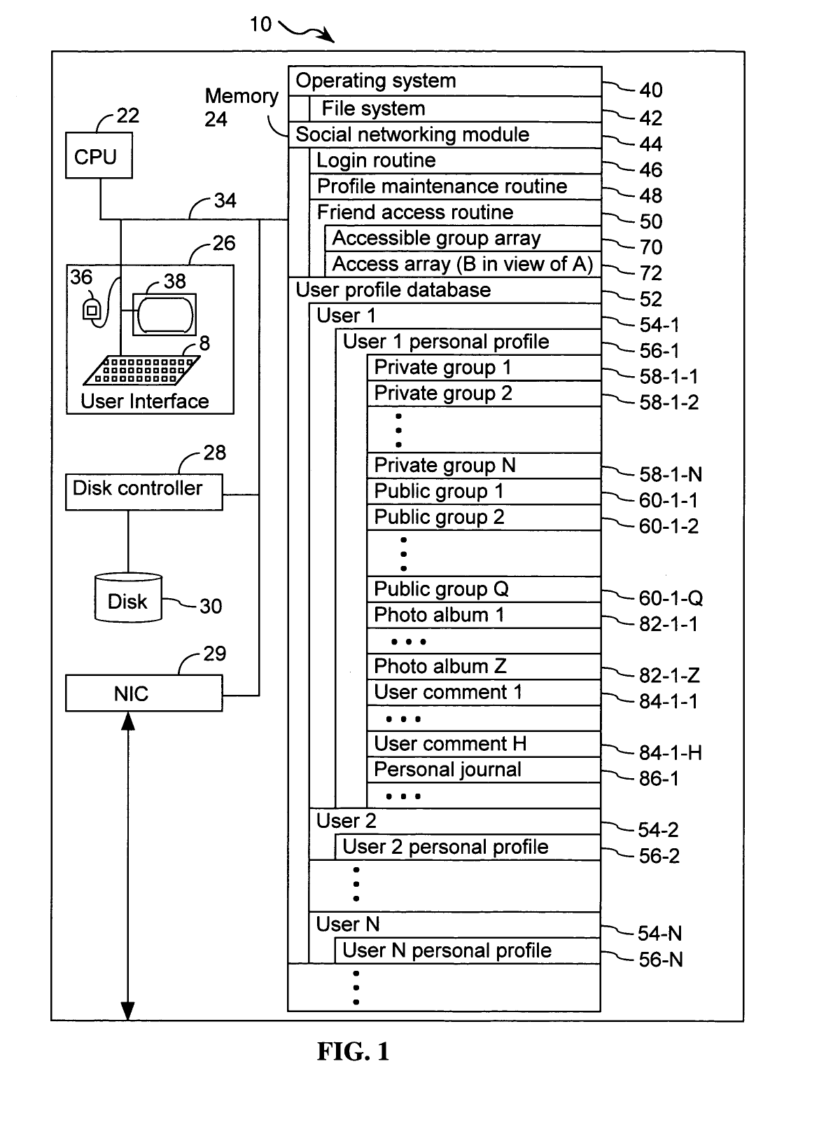

The present invention is directed to the ability to specify groups of friends in a social networking program. Using the example from the background, a user can specify a “co-workers group” and a “high school friends” group. Each of these groups share common resources, such as a bulletin board and the ability to send and receive group wide messages. For example, with bulletin boards, the members of a group can post to the bulletin board. The ability to specify such groups provides a distinct advantage over known social networking programs, where the paradigm has been to treat all friends of a given user as a single group. Moreover, in extensions of the present invention, in addition to segregating friends into groups, a user can assign such groups certain class privileges. For example, the user can designate certain of the groups as “public” and certain of the groups as “private.” Subject to the rules identified below, public groups are transparent to other users whereas the identity of members of private groups are only discoverable by the members of the private groups. For example, consider the case where user A segregates his friends into groups B, C, and D, where group B is public and groups C and D are private. A given user of the social networking system can learn the identity of a member of B provided that (i) user A is in a personal public group of the member of B, or (ii) user A and the given user of the social networking system are both in the same private group of the member of B. In other words, subject to rules (i) and (ii) above, specific users of the social networking system can learn that the specific users in group B are friends of user A. But no user of the social networking system can learn the identity of the members of group C, other than the members of group C themselves, because the group has been designated as private by user A. Likewise for group D, no user of the social networking system including the members of private group C can learn the identity of the members of private group D. That said, it is possible for user A to place his friends into more than one group. For instance, user A can place a friend into groups B, C, and D, or any combination thereof. Now that a brief overview of the features of the present invention have been presented, a system 10 that supports this functionality will be described in conjunction with FIG. 1. System 10 preferably includes:
a central processing unit (CPU) 22 (e.g., a full CPU such as an Intel pentium processor, or an application-specific integrated circuit, field-programmable gate array and the like)
a main non-volatile storage unit 30, for example a hard disk drive, for storing software and data, the storage unit 30 controlled by storage controller 28;
a system memory 24, preferably high speed random-access memory (RAM), for storing system control programs, data, and application programs, including programs and data loaded from non-volatile storage unit 30; system memory 24 may also include read-only memory (ROM);
a user interface 26, including one or more input devices (e.g., keyboard 8, mouse 36) and a display 38 or other output device;
a network interface card 29 for connecting to any wired or wireless communication network; and
an internal bus 34 for interconnecting the aforementioned elements of the system.

Operation of system 10 is controlled primarily by operating system 40, which is executed by central processing unit 22. Operating system 40 can be stored in system memory 24. In a typical implementation, system memory 24 includes:
operating system 40;
file system 42 for controlling access to the various files and data structures used by the present invention;
a social networking module 44 that provides traditional social networking services such as the ability to contact friends of friends, etc.; and
a user profile database 52 that includes the profiles 56 of a plurality of users 54 in an electronic social network.

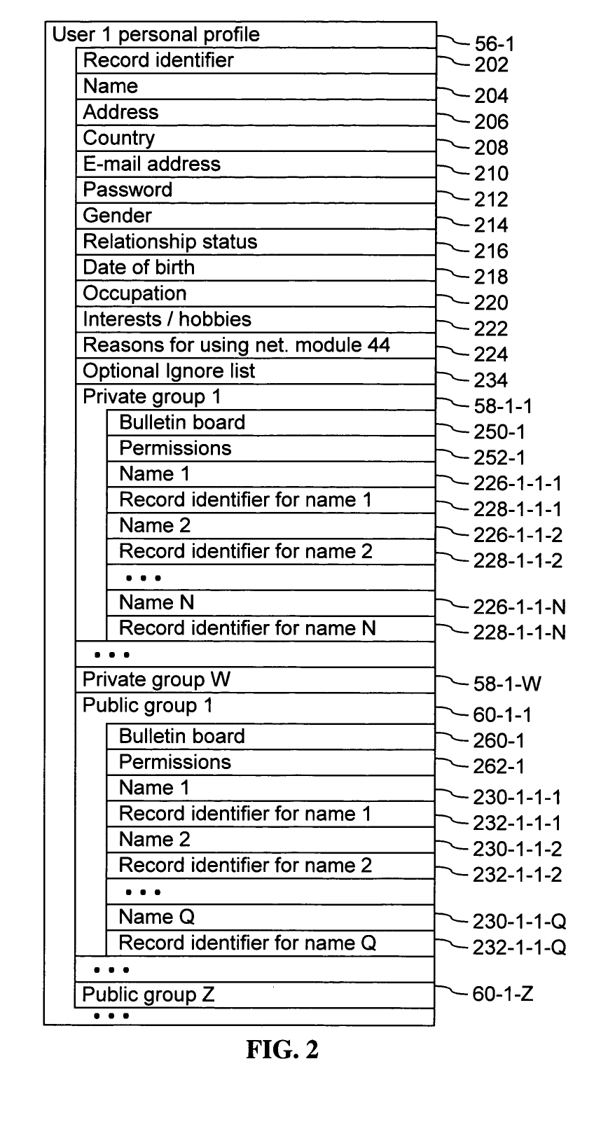

In a typical embodiment of system 10, social networking module 44 and user profile database 52 are stored on the same computer as illustrated in FIG. 2. However in embodiments not illustrated, system 10 comprises multiple computers, with social networking module 44, and user profile database 52 partitioned onto any number of computers that are addressable with respective to each other across a computer network.

As illustrated in FIG. 1, system 10 includes a database 52. This database 52 comprises any form of data storage system, including but not limited to, a flat file, a relational database (SQL), and an on-line analytical processing (OLAP) database (MDX and/or variants thereof). In some specific embodiments, user profile database 52 is a hierarchical OLAP cube. In some specific embodiments, user profile database 52 comprises a star schema that is not stored as a cube but has dimension tables that define hierarchy. Still further, in some embodiments, user profile database 52 has hierarchy that is not explicitly broken out in the underlying database or database schema (e.g., dimension tables are not hierarchically arranged).

The embodiment illustrated in FIG. 1 is that of a computer-based implementation of the present invention. In some embodiments in accordance with FIG. 1, social networking module 44 is implemented as a web-based application that can be run in a browser such as Windows Explorer or Netscape Navigator or as independent native Windows program. However, the methods of the present invention can be implemented in other forms of devices. For instance, in some embodiments of the present invention, the modules found in memory 24 of FIG. 1 are hosted by devices such as a cell phone, personal digital assistant, or the like.

Referring again to FIG. 1, user profile database 52 will now be presented in greater detail. User profile database 52 comprises a plurality of personal profiles 56. Each respective personal profile 56 in the plurality of personal profiles in profile database 52 uniquely represents a user of social networking module 44. Further, each respective personal profile 56 in the plurality of personal profiles in profile database 52 includes an identity of at least one user other than the user represented by the personal profile. More typically, each respective personal profile 56 in the plurality of personal profiles in profiles database 52 includes an identity of many other users. These many other users are referred to as the friends of the user represented by the personal profile 56. In some embodiments, there are at least five friends included within a given profile 56 in user profile database 54. In some embodiments, there are between 5 and 50 friends included within a given profile 56 in user profile database 54. In still other embodiments, there are more than 50 friends included within a given profile 56. In some embodiments, there are as many friends designated in a profile 56 as desired by the user corresponding to the profile 56. In some embodiments, the user corresponding to a profile 56 can specify a certain number of friends for free and for friends in excess of this certain number, must pay a fee.

Each respective personal profile 56 in the plurality of personal profiles includes a capability to organize the friends of the user corresponding to the respective personal profile 56 into a plurality of groups. For example, consider user personal profile 56-1 of FIG. 1. The friends of the user corresponding to personal profile 56-1 have been organized into private groups 58-1-1 through 58-1-N and public groups 60-1-1 through 60-1-Q. Each of groups 58 and groups 60 include one or more friends of the user corresponding to personal profile 56-1. While this example illustrates an instance where the user corresponding to personal profile 56-1 has segregated his friends into public and private groups, it will be understood that the present invention is not limited to such designations. In particular, some embodiments of the present invention do not have groups with public/private distinctions. For instance, in some embodiments, there are only public groups.

Each user profile 56 optionally includes other data modules including one or more photo albums 82 that each, in turn, include one or more digital photographs that have been uploaded by the user corresponding to the user profile 56. Photo albums 82 provide a way for user to post photographs for his friends to see. Photo albums 82 illustrate one of the many advantages of the usage of groups in a social network. With the advent of the novel groups of the present invention, a user is now able to prevent people who are not his friends from viewing certain photographs. In particular, if a user sets a photograph as public, every user of social networking module 44 can view the photograph. On the other hand, if the photograph is set as private, only members of a personal group that's been specifically given permission will be able to view the photograph. More detail on photo albums 82 in accordance with one embodiment of the present invention will be presented below.

Another data structure that is optionally included in personal profiles 56 is user comments 84. In the systems and methods of the present invention, a user comment 84 can only be left by a friend. Since each friend of the user must belong to at least one of the user's personal groups (e.g., belong to a group 58 or 60 in the profile of the user), a viewer's permission to see specific comments can be restricted as will be described in more detail below. Likewise, a user profile 52 optionally includes a personal journal 86. Personal journal 86 is a diary a member can write for himself each day. Friends will be able to view them depending on their permission, as will be described in more detail below.

FIG. 2 provides a more detailed embodiment of the types of information that can be stored in a personal profile 56. Each personal profile 56 optionally includes a record identifier that is used to uniquely track the personal profile. However, as can be appreciated by the description of the database 52 presented above, the presence of and nature of record 202 will depend on the characteristics of database 52, including whether it is a flat file, relational database, OLAP database, or the like. Typically, each personal profile includes personal information about the user corresponding to the profile, including the user's name 204, mailing address 206, country of residence 208, and E-mail address 210.

Users of social networking module 44 typically must provide a password in order to access the social network. In typical implementations of system 10, users are remotely located and they communicate with social networking module 44 via an Internet that is addressable by network interface card 29. For example, in one embodiment of the present invention, social networking module 44 (FIG. 1) includes a login routine 46 and a user provides a password. If the password presented by the user matches the password 212 stored in the user's profile, login routine 46 grants the user access to the social network.

In some embodiments of the present invention, a personal profile 56 in database 52 includes personal information relating to the user corresponding to the personal profile 56. Such information may include, but is not limited to, the gender 214 of the user, the relationship status 216 of the user (single, married, divorced, looking for serious relationship, etc.), the date of birth 218 of the user, the occupation 220 of the user, and any interests or hobbies 222 of the user that the user would like other users of social networking module 44 to know about.

Social networking module 44 is used to interact with other people. Each user of the social networking module has specific reasons for interacting with other people. These reasons can include romantic interests, business purposes, shared hobbies, or just to communicate with friends. The reasons why a given user of social networking module uses the module can be stored in field 224 of the personal profile 56 that corresponds to the given user.

In some unfortunate instances, a user of social networking module 44 may have an unfavorable interaction with another user of the network. This unfavorable interaction may be in the form of harassment, lack of interest in another user, etc. To address this problem, in some embodiments of personal profile 56, there is a field 234 that stores the name of the users that a given user wants to ignore.

Members can set their own personal profile 56 on the system. In some embodiments, the personal profile includes such items as an e-mail address, a first name, a last name, date of birth, gender, height, weight, phone number, location, address to a personal website, what they're looking for (e.g., dating, friendship, pen-pal, etc.), what sex they're attracted to, marital status, children, languages they speak, whether they smoke, whether they drink and how much they drink, religious preference, favorite music, favorite TV/movies, favorite books, favorite foods, hobbies, who they want to meet, an “about me” biographical summary, education level, where they went to school, employment history, income level, etc. With each of the above listed fields and/or any of the field illustrated in FIG. 2, which is by no means limited to these examples, the user is able to set the field (e.g., fields 204-234) as public or private. If a field in a profile is set as public, then any user of system 10 will be able to view that entry.

If a user 54 sets an entry in his personal profile 56 as “private,” then only those users of system 10 that are granted special personal profile view permission will be able to view such entries. When defining permissions 252/262 for a personal group (e.g., a private group 58 and/or a public group 60), the user 54 is able to specify if members of such a group have permission to view the private profile fields in the user's personal profile 56. If such permission is granted, then users in that group will be able to see those entries. If the permission is not granted, then they will not be able to view those entries.

As discussed above, a personal profile 56 in user profile database 52 may include the identity of the groups of friends associated with the user corresponding to the personal profile 56. In the embodiments, illustrated in FIG. 1 and FIG. 2, there are two classes of personal groups, personal private groups 58 and personal public groups 60. However, the invention is not limited to such classes of groups. For example, in some embodiments, there are only public groups 60 in a personal profile 56 and no private groups 58. Each public group 60 lists one or more names 230 of users of social networking module 44. Each such user 230 has their own corresponding personal profile 56 in user profile database 52. In some embodiments, each of these personal profiles 56 is referenced by the unique record identifiers associated with each such user. Thus, in some embodiments, in addition to storing the names 230 of friends, a private group stores the corresponding record identifiers 232 of the friends. In embodiments where personal profiles store private groups 58, the private groups include the names 226 of one or more friends of the user, where each name 226 refers to a user of social networking module 44 that has their own personal profile 58 in user profile database 52. Like the case of public groups 60, in some embodiments, the profiles of the friends 226 in a private group 58 can be located in user profile database 52 by unique record identifiers 228 associated with such users. It will be appreciated that the record identifier 202 of user 56-1 is equivalent to the record identifiers 228 of private groups 58 and the record identifiers 232 of public groups 60, with the exception being that each record identifier is unique to a particular user of user profile database 52.

Now that an overview of a system 10 and various data modules stored within system 10 in accordance with one embodiment of the present invention have been described, various advantageous methods in accordance with the present invention will now be disclosed in the following sections.

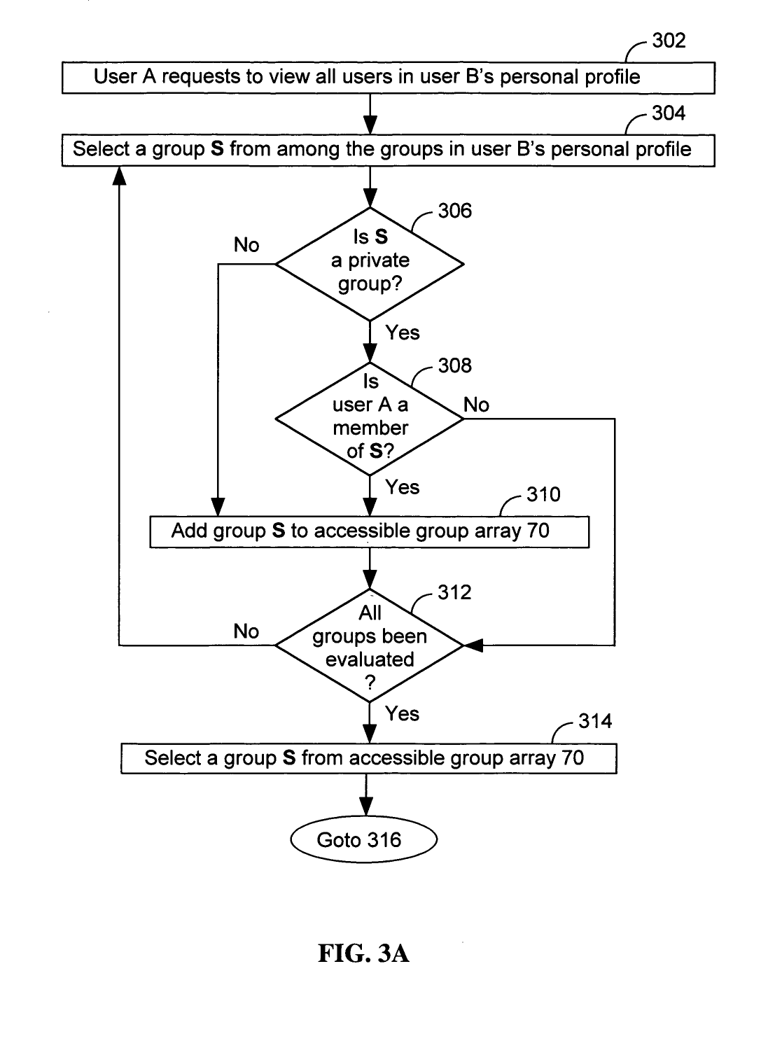

FIG. 3 illustrates the exemplary steps that are taken when user A asks for the identity of user B's friends. In other words, user A asks for the identity of the users that are stored in the various groups in the personal profile 56 that correspond to user B. The exemplary steps of FIG. 3 describe a method that determines which of user B's friends will be disclosed to user A and which of user B's friends will not be disclosed to user A. Here, user A and user B are both users of social networking module 44. Therefore, user A and user B each have their own personal profile 56 stored in user profile database 52. In some embodiments of the present invention the steps described in FIG. 3 are performed by friend access routine 50 of social networking module 44 (FIG. 1).

When user A requests to view all users in user B's personal profile 52 (FIG. 3, step 302), the groups in user B's personal profile are obtained from the personal profile. Then, step 304 begins a logical loop in which a group S is selected from among the groups in user B's personal profile 56. Next, in embodiments where the personal profiles 56 of user profile database 52 include both public 60 and private 58 groups, a check 306 is made to determine whether the group is private or a public. If group S is a public group (306-No), then the group is added to an accessible group array (accessible group list) 70 (310). Accessible group array 70 is a temporary data construct used by friend access routine 50 of social networking module 44 to track the groups of friends in user B's personal profile that may be eligible for review by user A in subsequent processing steps. If, on the other hand, group S is a private group (306-Yes) process control passes to step 308 where a determination is made as to whether user A is a member of group S. If so (308-Yes), group S is added to the accessible group array 70. If not (308-No), user A is not eligible to learn the identity of group S or any member of group S and so the group is not added to the accessible group array (accessible group list) 70.

In step 312, a determination is made as to whether all the groups in the profile of user A have been considered by loop 304-312. If not (312-No), process control returns to step 304 where a new group S from among the groups in user B's personal profile 56 is selected for evaluation by loop 312. Loop 304-312 is repeated for each group in the personal profile of user B. Note that in embodiments where private groups 58 are not supported, loop 304-312 is not needed. In such embodiments, all groups in the personal profile 56 corresponding to user B are considered in subsequent processing steps.

Steps 304-312 served to determine which groups in the personal profile 56 corresponding to user B should be evaluated. Step 314 begins the process of evaluating each friend listed in the groups qualified by steps 306-312 (e.g., the groups in accessible group array 70). In particular, in step 314 a group S in the accessible group array 70 is selected for evaluation. Note that, in embodiments where private groups 58 is not supported, step 314 reduces to selecting any one of the public groups 60 in the personal profile 56 corresponding to user B that has not been selected by a previous instance of step 314.

Step 316 begins loop 316-328, which iterates through each user C in the group S, where group S is the group selected in the last instance of step 314. Step 318 represents an optional step in loop 316-328 in which a determination is made as to whether user A is in user C's ignore list 234. If so (318-Yes), the identity of user C will not be made available to user A. If not (318-No), user A remains eligible to learn the identity of user C provided that additional tests provided in loop 316-328 are passed.

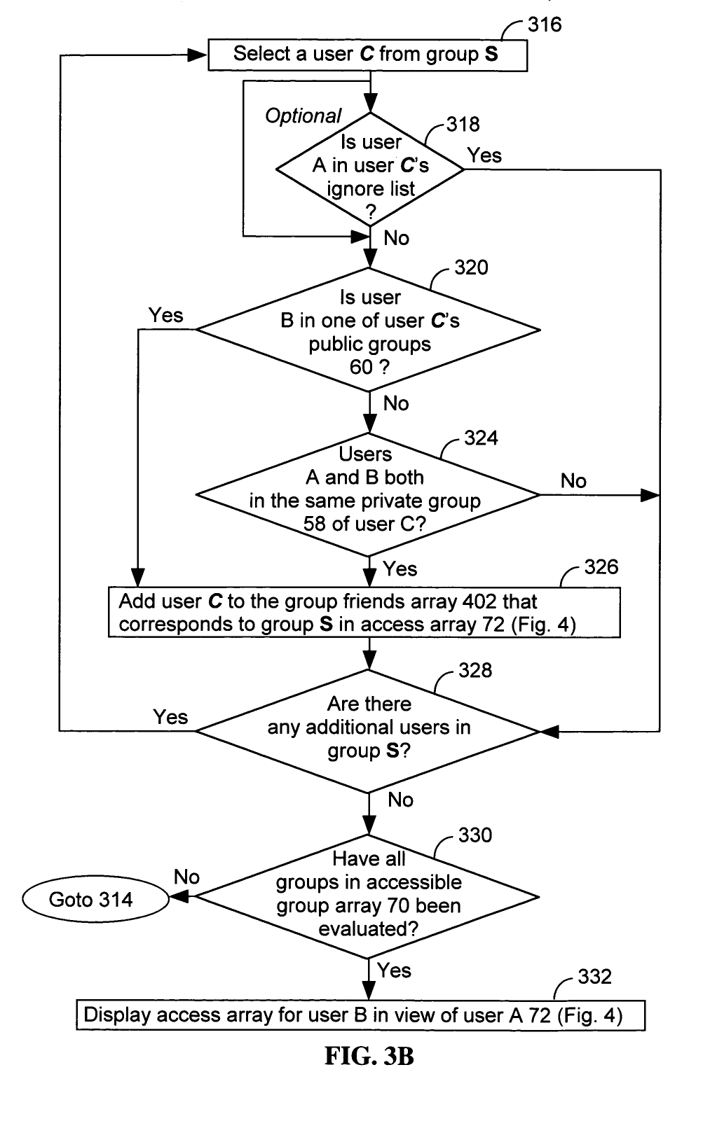

The additional steps in loop 316-328 are designed to determine whether user C would object to the disclosure that user B and user C are friends. If user B is in one of user C's public groups 60, then it is clear that user C would not object to the disclosure that user C and user B are friends. Thus, in step 320, a determination is made as to whether user B is in one of user C's public groups 60. In other words, friend access routine 50 reviews the identity of each of the users in each of the public groups 60 in the personal profile 56 corresponding to user C to see of user B is a member of any of these public groups. If so (320-Yes), user C is added to the group friends array 402 in access array (access list) 72 that corresponds to the group S selected in the last instance of step 314 (step 326). FIG. 4 shows more details of access array 72. Each group of friends (58/60) in accessible group array 70 (or in embodiments that do not have private groups 58, each group 60 associated with user A) is represented by a friends array 402. Thus, each iteration of loop 316-328 determines which users 404 are added to the friends array 402 that corresponds to the group S selected in the last instance of step 314.

Even if user B is not in one of User C's public groups, it may still be possible for user A to learn of the friendship between user B and user C if user A and user B are both in the same private group 58 of user C. If they are (324-Yes), then user C is added to the group friends array 402 corresponding to group S in access array 72 (step 326). If it is the case that (i) users A and B are not both in the same private group 58 of user C and (ii) user B is not in any of user C's public groups 60 (324-No), then user C is not added to the group friends array 402.

In step 328, a determination is made as to whether there are any additional users in group S to examine, where group S refers here to the group selected in the last instance of step 314. If there are remaining users in group S to examine (328-Yes), process control returns to step 316 and loop 316-328 is repeated for another user in group S. If all users in group S have been evaluated by loop 316-328 (328-No), then process control passes to step 330.

In step 330, a determination is made as to whether all groups in accessible group array (accessible group list) 70 have been evaluated by an instance of loop 314-328. In embodiments where profiles 56 do not have private groups 58, step 330 reduces to making a determination as to whether all groups in the profile 56 corresponding to user B have been evaluated by an instance of loop 314-328. If all eligible groups have not been evaluated (330-No), process control returns to step 314 where another group is selected for evaluation by loop 314-328. If all groups have been evaluated (330-Yes), process control passes to step 332 where access array for user B in view of user A 72 is displayed to user A.

One of skill in the art will appreciate that the format by which array 72 is displayed to user A can take many different forms. For instance, in some embodiments, group information in array 72 is suppressed and just the names of users 404 that are found in any array 404 of access array (access list) 72 are provided to user A. This list could be in alphabetical order or any other suitable order. In still other embodiments, step 332 involves displaying array 72 in a way that reveals the logical structure of array 72, with users 402 arranged into the groups found in the personal profile 56 of user B.

Methods for identifying which friends are disclosed to others based on information in user's personal profile 56 have now been disclosed. This same logic is used to regulate who sees user comments 84 and personal journals 86 (FIG. 1). As described above, user comments 84 can only be left by a friend of the user corresponding to a personal profile 56. Thus, if a third user does not have the appropriate privilege to learn that the posting user and the user corresponding to the personal profile 56 are friends, then the third user cannot see the posted message. The case where users A, B, and C of FIG. 3 are considered is instructive to illustrate the point. User A wishes to see the user comments 84 of user B. Each user comment 84 is posted by a friend of user B, including a user comment 84 posted by user C. So, to determine whether user A can view this user comment 84, a determination is made as to whether user A has the privilege to learn that user B and user C are friends. This determination is made used the procedure disclosed in FIG. 3. If user A can learn that user B and C are friends, then user A can review the user comments 84 posted by user C that are stored in user B's personal profile 56.

As described above, in some embodiments of the present invention, personal profiles 56 include personal journals. A personal journals 86 is a diary that a member can right for himself each day. Friends will be able to view diary entries depending on their permissions. For instance, using the example of users A, B, and C from above, consider the case in which user B has a personal journal 86 with a diary entry in which user C is identified. User A will only be able to review this diary entry if he has the privilege to learn that user B and user C are friends, as determined by the procedures outlined in FIG. 3.

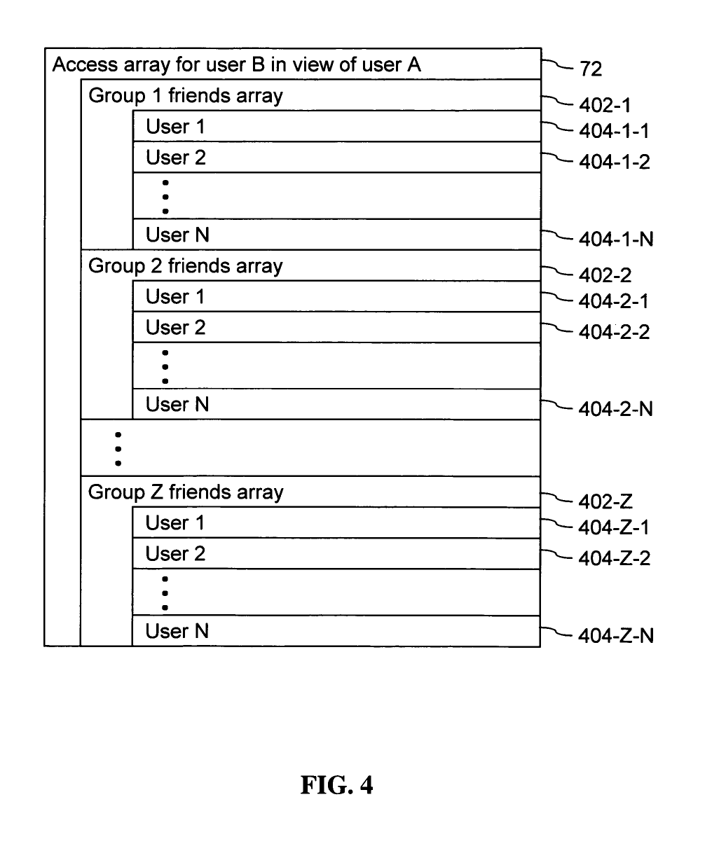

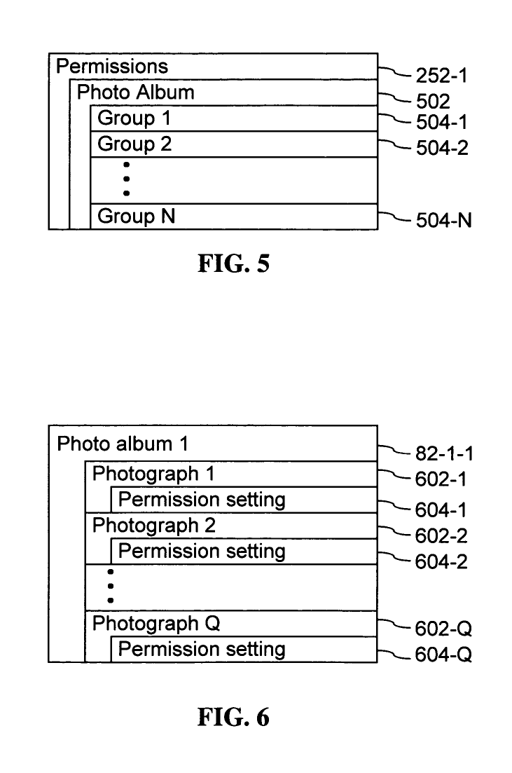

Embodiments of the present invention have been present in which a user can designate personal groups, such as public groups 60. In some embodiments, the user can also designate private groups 58. The present invention provides additional control over content in social networks. FIG. 1 illustrates how users can include photo albums 82 in their personal profiles 56. FIGS. 5 and 6 illustrate data structures that allow users to control which users see individual photographs within these albums 82. In particular, referring to FIG. 6, a user is able to designate each respective photograph 602 in a photo album 82 as public or private using the permission setting 604 that corresponds to the photograph 602. If a user sets permission setting 604 so that the corresponding photograph 602 is public, all users of social networking module 44 will be able to view the photograph 602. If, on the other hand, a user sets the photograph 602 as private using the associated permission setting 604 (FIG. 6) only members of a personal group (e.g., members of a public group 60) that's been specifically granted permission will be able to view the photograph 602. As an example, consider the case in which user Jason upload five photographs 602 into a photo album 82 in the personal profile 56 associated with Jason. Jason only wants photographs 2 and 3 to be viewable by members his personal public group 60 “Family.” Jason does two things two effect this desire. First, he sets the permission 604 associated with FIGS. 2 and 3 to “private photos.” Then, he edits the permissions of the family group to grant them permission to view these “private” photos. In some embodiments, the permissions that need to be edited to grant this permission is permissions 252, in the case where the group is a private group 58, and permissions 262 in the case where the group is a public group 60 (FIG. 2). The logical structure of permissions 252 and 262 are the same, different nomenclature is assigned merely to reflect that such permissions reside in groups 58 and 60, respectively.

FIG. 6 illustrates one logical structure for permissions 252 that are found in a private group 58. In this exemplary embodiment of permissions 252, there is includes a permission setting 502 for photo albums. Permission setting 502 includes a field 504 for each of the groups in the profile corresponding to permission setting 502. For example, consider a personal profile 56 that includes three public groups and no private groups. In this example, there would be three entries 504 in the permission setting 502 for photo albums. Further, in instances where there is more than one photo album 82 in the user profile, there is a corresponding number of permissions 502 (e.g. 502-1, 502-2, and so forth), one for each photo album 82, where each permission 502 includes an entry 504 for each group in the profile. As an example, in the case where there are two photo albums 82 and three public groups 60 in a given personal profile 56, there will be a permission 502-1 and a permissions 502-2 in the permissions data structure 252. Further, both permission 502-1 and permission 502-2 will each contain three entries, one for each pubic group 60 in the profile. When a user sets photographs 602 in a photo album 82 as private, the user then sets individual permissions 504 in the photo album permission record 502 that corresponds to the photo album 82 to enable specific groups to review the private photographs. In this way, a user can determine which groups in his personal profile can review photographs that have been marked as private. Those of skill in the art will appreciate that there are any number of different ways in which permissions 252 can be structured so that a user can specify which groups can see his private photographs and which groups cannot, and all such implementations of the concept are within the scope of the present invention.

Bulletin boards allow people to interact with each other online, posting new topics and replying to someone else's topics. With the use of the novel personal groups of the present invention (e.g., public groups 60 and, optionally, private groups 58), such bulletin boards can be categorized so that only people within a respective personal group can post to the respective group's bulletin board. All non-members will not be able to post to the respective bulletin board. Also, a user can now prevent non-members of his personal private groups from not only posting, but viewing the bulletin board postings. This is a fine-grained control in which a user has absolute control over who gets to see and do what with his group of friends.

In one embodiment of the present invention, each public group 60 has a bulletin board 260 and each private group 58 has a bulletin board 250. Public bulletin boards 260 have the feature that all users, whether they are members of the same personal public group or not, can view the posts and replies made by viewable members of the group. Recall from FIG. 3, that a user C, a poster of a message on the bulletin board 260 of viewer B, will be viewable to user A when (i) user B is in one of C′ public groups or (ii) user A and user B are in the same private group as user C. Private bulletin boards 250 have the feature that only members of the personal private group may view the posts and replies made by viewable members of the group, where the rules for determining who is a viewable member are as defined by the method illustrated in FIG. 3.

In some embodiments of the present invention, social networking module 44 includes profile maintenance routine 48 that is used by users to update any of the data in the personal profile 56 associated with the user.

All references cited herein are incorporated herein by reference in their entirety and for all purposes to the same extent as if each individual publication or patent or patent application was specifically and individually indicated to be incorporated by reference in its entirety for all purposes.

Many modifications and variations of this invention can be made without departing from its spirit and scope, as will be apparent to those skilled in the art. Reference has been made to certain computer systems. However, the present invention contemplates implementation of the inventive methods on any form of technology, whether currently existing or to be developed in the future, that implements electronic social networking. The specific embodiments described herein are offered by way of example only, and the invention is to be limited only by the terms of the appended claims, along with the full scope of equivalents to which such claims are entitled.

1. A computer program product for use in conjunction with a system, the computer program product comprising a computer readable storage medium and a computer program mechanism embedded therein, the computer program mechanism comprising:
a user profile database comprising a plurality of personal profiles, wherein
each respective personal profile in said plurality of personal profiles corresponds to a user in a computerized social network,
each respective personal profile in said plurality of personal profiles includes an identity of at least one user other than the user represented by the respective personal profile; and
each respective personal profile in said plurality of personal profiles includes a capability to organize each said at least one user into a plurality of groups associated with the user corresponding to the respective personal profile; and
a social networking module for supporting said computerized social network, wherein said social networking module further comprises a friend access routine that includes:
instructions for receiving a request from a first user to access users in the personal profile of a second user; and
instructions for determining which of the users in the personal profile of the second user can be accessed by the first user.

2. The computer program product of claim 1 wherein said instructions for determining which of the users in the personal profile of the second user can be accessed by the first user comprise:
(A) instructions for selecting a group in the personal profile of the second user;
(B) instructions for determining whether said group selected by an instance of the instructions for selecting is a private group or a public group, wherein
when said group is a public group, said group is added to an accessible group array, and
when said group is a private group, said instructions for determining further comprise instructions for determining whether said first user is a member of said private group and wherein,
when said first user is a member of said private group, said group is added to said accessible group array, and
when said first user is not a member of said private group, said group is not added to said accessible group array;
(C) instructions for repeating instructions (A) and instructions (B) until each group in the personal profile of the second user has been evaluated; and
(D) instructions for granting access to users in each of the groups in the accessible group array to said first user.

3. The computer program product of claim 2 wherein said instructions for granting access to users in each of the groups in the accessible group array comprise:
(i) instructions for selecting a group G from said accessible group array;
(ii) instructions for selecting a user C from the group G selected in the last instance of the instructions for selecting (i);
(iii) instructions for determining whether said second user is in a public group in the personal profile associated with said user C, wherein
when said second user is in a public group defined by the personal profile associated with said user C, said user C is added to an access array, and
when said second user is not in a public group defined by the personal profile associated with said user C, said instructions for determining (iii) further comprise instructions for determining whether said first user and said second user are both in the same private group defined by said user C's personal profile, wherein
when said first user and said second user are both in the same private group defined by said user Cs personal profile, said user C is added to said access array, and
when said first user and said second user are not both in the same private group defined by said user Cs personal profile, said user C is not added to said access array;
(iv) instructions for repeating said instructions for selecting (ii) and said instructions for determining (iii) until each user in the group G has been considered;
(v) instructions for repeating instructions (i) through (iv) until each group G in said accessible group array has been considered; and
(vi) instructions for granting said first user access to each user in the access array.

4. The computer program product of claim 3 wherein a target user has a personal profile defining a public group that includes a bulletin board for sending and receiving messages between users in the public group and wherein said first user cannot review messages in said bulletin board unless said target user is in the access array.

5. The computer program product of claim 3 wherein a target user has a personal profile defining a private group that includes a bulletin board for sending and receiving messages between users in the public group and wherein said first user cannot review messages in said bulletin board unless said first user is in said private group.

6. The computer program product of claim 1 wherein a personal profile in said plurality of personal profiles comprises a photograph album having a plurality of photographs, and wherein each photograph in said plurality of photographs includes an access designation, wherein
when the access designation of a photograph in said plurality of photographs is in a first setting, each user of the computerized social network can access said photograph; and
when the access designation of a photograph in said plurality of photographs is in a second setting, a user of the computerized social network cannot access said photograph unless said user is a member of a group, defined by said profile, that has access privilege to said photograph when the access designation of said photograph is in said second setting.

7. The computer program product of claim 3 wherein a target user has a personal profile including one or more user comments posted by users within one or more groups defines by said personal profile and wherein said first user cannot review said one or more user comments unless said target user is in the access array.

8. The computer program product of claim 3 wherein a target user has a personal profile including a personal journal for posting journal entries written by said target user, and wherein said first user cannot review said personal journal unless said target user is in the access array.

9. The computer program product of claim 3 wherein the user C has a personal profile that includes an ignore list and when said first user is in said ignore list, said user C is not added to said access array regardless of whether said second user is in a public group defined in the personal profile associated with user C and regardless of whether said first user and said second user are in the same private group defined by said user Cs personal profile.

10. The computer program product of claim 1 wherein a personal profile in said plurality of personal profiles includes a name of the user corresponding to the personal profile.

11. The computer program product of claim 1 wherein a personal profile in said plurality of personal profiles includes an address of the user corresponding to the personal profile.

12. The computer program product of claim 1 wherein a personal profile in said plurality of personal profiles includes a password of the user corresponding to the personal profile.

13. The computer program product of claim 1 wherein a personal profile in said plurality of personal profiles includes an interest or hobby of the user corresponding to the personal profile.

14. The computer program product of claim 1 wherein a personal profile in said plurality of personal profiles includes an occupation of the user corresponding to the personal profile.

15. The computer program product of claim 1 wherein said social networking module further comprises a profile maintenance routine, said profile maintenance routine including instructions for facilitating an update of a personal profile in said plurality of personal profiles by the user corresponding to said personal profile.

16. The computer program product of claim 1 wherein said one or more groups includes a public group.

17. The computer program product of claim 1 wherein said one or more groups includes a private group.

18. The computer program product of claim 1 wherein said social networking module further comprises a login routine, said login routine including instructions for allowing a user to access the personal profile corresponding to the user in the user profile database.

19. The computer program product of claim 1 wherein a personal profile in said plurality of personal profiles includes one or more fields describing the user corresponding to the personal profile and wherein the computer program mechanism further includes instructions for designating each of the fields in the one or more fields as public or private.

20. The computer program product of claim 19, the computer program mechanism further including instructions for granting access to users of a group in said plurality of groups access to a field in said personal profile when said field has been designated as private.

21. The computer program product of claim 1 wherein the system is a computer, cell phone, or personal digital assistant.

22. A system for hosting a computerized social network, the computer system comprising:
a central processing unit;
a memory, coupled to the central processing unit, the memory storing a user profile database and a social networking module, wherein
the user profile database comprises a plurality of personal profiles, and wherein
each respective personal profile in said plurality of personal profiles corresponds to a user in said computerized social network,
each respective personal profile in said plurality of personal profiles includes an identity of at least one user other than the user represented by the respective personal profile, and
each respective personal profile in said plurality of personal profiles includes a capability to organize each said at least one user into one or more groups associated with the user corresponding to the respective personal profile; and wherein
the social networking module comprises a friend access routine that includes:
instructions for receiving a request from a first user to access users in the personal profile of a second user; and
instructions for determining which of the users in the personal profile of the second user can be accessed by the first user.

23. The system of claim 1 wherein the system is a computer, cell phone, or personal digital assistant.

24. A computer program product for use in conjunction with a system, the computer program product comprising a computer readable storage medium and a computer program mechanism embedded therein, the computer program mechanism for facilitating a computerized social network, the computer program mechanism comprising
a user profile database comprising a plurality of personal profiles;
each respective personal profile in said plurality of personal profiles corresponding to a user in a computerized social network,
each respective personal profile in said plurality of personal profiles including an identity of at least one user of the computerized social network other than the user represented by the respective personal profile, and
each respective personal profile in said plurality of personal profiles including a capability to organize each said at least one user into one or more groups associated with the user corresponding to the respective personal profile.

25. The computer program product of claim 24 wherein the system is a computer, cell phone, or personal digital assistant.

26. A method for determining which of a plurality of users in a personal profile of a second user can be accessed by a first user, wherein said plurality of users are organized into a plurality of groups in said personal profile, the method comprising:
(A) receiving a request from said first user to access said plurality of users in the personal profile of said second user, wherein said first user and said second user are participants in a social network;
(B) selecting a group in the plurality of groups in the personal profile of the second user;
(C) determining whether said group selected by said selecting (B) is a private group or a public group, wherein
when said group is a public group, said group is added to an accessible group list, and
when said group is a private group, said determining (C) further comprises determining whether said first user is a member of said private group and wherein,
when said first user is a member of said private group, said group is added to said accessible group list, and
when said first user is not a member of said private group, said group is not added to said accessible group list;
(D) repeating (B) and (C) until each group in the personal profile of the second user has been evaluated; and
(E) granting access to users in each of the groups in the accessible group list to said first user.

27. The method of claim 26 wherein said granting (E) comprises:
(i) selecting a group G from said accessible group list;
(ii) selecting a user C from the group G selected in the last instance of said selecting (i);
(iii) determining whether said second user is in a public group in a personal profile associated with said user C, wherein
when said second user is in a public group defined by the personal profile associated with said user C, said user C is added to an access list, and
when said second user is not in a public group defined by the personal profile associated with said user C, said determining (iii) further comprises determining whether said first user and said second user are both in the same private group defined by said user Cs personal profile, wherein
when said first user and said second user are both in the same private group defined by said user Cs personal profile, said user C is added to said access list, and
when said first user and said second user are not both in the same private group defined by said user Cs personal profile, said user C is not added to said access list;
(iv) repeating said selecting (ii) and said determining (iii) until each user in the group G has been considered;
(v) repeating (i) through (iv) until each group G in said accessible group list has been considered; and
(vi) granting said first user access to each user in the access list.

28. A method for hosting a social network that includes a user profile database comprising a plurality of personal profiles, wherein
each respective personal profile in said plurality of personal profiles corresponds to a user in said social network,
each respective personal profile in said plurality of personal profiles includes an identity of at least one user other than the user represented by the respective personal profile, and
each respective personal profile in said plurality of personal profiles includes a capability to organize each said at least one user into one or more groups associated with the user corresponding to the respective personal profile; the method comprising:
(A) receiving a request from a first user to access users in the personal profile of a second user;
(B) selecting a user C from a group G in the personal profile of said second user;
(C) determining whether said second user is in a group in a personal profile associated with said user C, wherein
when said second user is in a group defined by the personal profile associated with said user C, said user C is added to an access list, and
when said second user is not in a group defined by the personal profile associated with said user C, said user C is not added to said access list;
(D) repeating said selecting (B) and said determining (C) until each user in the group G has been considered;
(E) repeating (B) through (D) until each group G in the personal profile of the second user has been considered; and
(F) granting said first user access to each user in the access list.
